(19) United States
(12) Patent Application Publication
(10) Pub. No.: US 2024/0369897 A1
(43) Pub. Date: Nov. 7, 2024

(54) OPTICAL TRANSMISSION DEVICE AND OPTICAL TRANSMISSION METHOD

(71) Applicant: MITSUBISHI ELECTRIC CORPORATION, Tokyo (JP)

(72) Inventor: Hayato SANO, Tokyo (JP)

(73) Assignee: MITSUBISHI ELECTRIC CORPORATION, Tokyo (JP)

(21) Appl. No.: 18/774,031

(22) Filed: Jul. 16, 2024

Related U.S. Application Data
(63) Continuation of application No. PCT/JP2022/012110, filed on Mar. 17, 2022.

(51) Int. Cl. G02F 1/225; G02B 6/12; G02F 1/01; H04B 10/50

(52) U.S. Cl. CPC G02F 1/225; G02B 6/12; G02F 1/0123; G02B 2006/12142; H04B 10/505

(57) ABSTRACT

An optical transmitter includes: optical modulators to optically modulate intensities of branched lights obtained by branching a laser light having a single wavelength emitted from a single light source by respective channel signals independent of each other, and output the optically modulated branched lights as optical signals; and a modulation light multiplexer to multiplex the optical signals output from the optical modulators and output a multiplexed optical signal.

### CROSS REFERENCE TO RELATED APPLICATION

This application is a Continuation of PCT International Application No. PCT/JP2022/012110, filed on Mar. 17, 2022, which is hereby expressly incorporated by reference into the present application.

### TECHNICAL FIELD

The present disclosure relates to an optical transmission technology.

### BACKGROUND ART

In the field of optical fiber communication, a binary non return to zero (NRZ) modulation scheme is often adopted in the conventional optical intensity modulation and direct detection scheme. A capacity of communication is continuously increased, and in recent years, for example, a 4-level pulse amplitude modulation (PAM4) scheme, which is one of multi-value modulation schemes, is adopted in a 400 Gbps-class optical intensity modulation and direct detection scheme.

In contrast, in the field of wireless communication, in recent years, the 5th generation of a wireless access network has been partially introduced, and orthogonal frequency division multiplexing (OFDM) scheme using quadrature amplitude modulation (QAM) of 64 values is applied to a radio signal.

In order to implement a future wireless access network such as the 6th generation, an optical fiber wireless technology has been widely studied in which a radio analog signal is directly put on an optical carrier wave and transmitted via an optical fiber for signal transmission of data information in a mobile fronthaul and the like. As one of the technologies, an IF-over-Fiber (IFOF) technology capable of accommodating an OFDM signal of a plurality of channels with one optical fiber by frequency-converting a plurality of analog radio signals into signals in an intermediate frequency (IF) band and frequency-multiplexing the signals in the intermediate frequency band has been studied.

In the IFOF technology, channels having occupied bands of several hundred MHz class to GHz class are multiplexed in a frequency domain, so that a broadband optical transmitter for putting such a broadband IF signal on the optical carrier wave and generating the optical signal is required. Non-Patent Literature 1 proposes an IFOF technology in which one broadband link and a plurality of narrowband links are connected in a cascade manner.

### CITATION LIST

### Non-Patent Literature

Non-Patent Literature 1: “Cascaded IF-Over-Fiber Links With Hybrid Signal Processing for Analog Mobile Fronthaul”, K. Tanaka et al., JOURNAL OF LIGHTWAVE TECHNOLOGY, VOL. 38, NO. 20, Oct. 15, 2020, pp. 5656-5667.

### SUMMARY OF INVENTION

### Technical Problem

In an optical communication network to which a non return to zero (NRZ) modulation scheme for transmitting one bit (binary of 1 and 0) in one symbol is applied, an optical transmitter using an optical modulator such as an electro-absorption (EA) modulator has a characteristic of high speed and high output, and is widely used. On the other hand, in the optical modulator such as the EA modulator, a modulation curve indicating a response of an optical signal to an electrical signal has a non-linear characteristic, so that there has been a problem that a driving condition of the optical modulator is significantly limited when multi-value modulation is performed.

In the IFOF technology, if signals of a plurality of channels can be accommodated by frequency multiplexing by an optical carrier wave of one wavelength using an optical transmitter with one optical carrier wave, a cost reduction and an increase in capacity can be expected. However, as the number of channels increases, driving amplitude of a modulation signal for transmission input to the optical modulator increases, leading to optical modulation in a non-linear region of the EA modulator. When the optical modulation is performed in the non-linear region, a signal quality of the optical signal is deteriorated, so that there has been a problem that the number of channels to be frequency-multiplexed is limited.

The present disclosure has been made with recognition of such problem as a trigger, and an object thereof is to provide an optical modulation technology capable of performing optical modulation with a modulation signal accommodating signals of a plurality of channels.

### Solution to Problem

An aspect of an optical transmission device according to embodiments of the present disclosure includes an optical transmitter comprising:
optical modulators to optically modulate intensities of branched lights obtained by branching a laser light having a single wavelength emitted from a single light source by respective channel signals independent of each other, and output the optically modulated branched lights as optical signals;
optical power adjusters to adjust respective optical powers of the optical signals output from the optical modulators, and output the adjusted optical signals; and
a modulation light multiplexer to multiplex the optical signals output from the optical power adjusters and output a multiplexed optical signal;

a modulation signal generator, connected in parallel to the optical modulators, to generate a same number of channel signals each including signals independent of each other as a number of the optical modulators, and output the generated channel signals as the channel signals independent of each other to the optical modulators; and

an optical power controller, connected in parallel to the optical power adjusters, to adjust optical powers output from the optical power adjusters freely.

### Advantageous Effects of Invention

According to one aspect of an optical transmitter according to embodiments of the present disclosure, optical modulation can be performed with a modulation signal accommodating signals of a plurality of channels.

### BRIEF DESCRIPTION OF DRAWINGS

FIG. 1 is a block diagram illustrating a configuration of an optical transmission device according to a first embodiment of the present disclosure.

FIG. 2 is a graph illustrating a relationship between an extinction curve characteristic and a DC bias voltage in an EA modulator according to the first embodiment of the present disclosure.

FIG. 3A is a graph illustrating an example of a driving amplitude and a waveform of optical modulation in the EA modulator according to the first embodiment of the present disclosure. It is illustrated that linear optical modulation can be performed in a case where the driving amplitude is small.

FIG. 3B is a graph illustrating an example of a driving amplitude and a waveform of optical modulation in the EA modulator according to the first embodiment of the present disclosure. It is illustrated that non-linear optical modulation is performed in a case where the driving amplitude is large.

FIG. 4 is a diagram for describing a principal of optical modulation in the EA modulator according to the first embodiment of the present disclosure. For simplicity, a complex conjugate component on a negative frequency side is not illustrated.

FIG. 5 is a diagram illustrating a configuration of an optical transmitter including an EA modulator widely used in the field of optical communication.

FIG. 6A is a diagram for describing a relationship between an IF signal and an optical carrier wave and a relationship between an optical transmitter and an optical receiver when using an optical transmission device according to a comparative example.

FIG. 6B is a diagram for describing a relationship between an IF signal and an optical carrier wave and a relationship between an optical transmitter and an optical receiver when using an optical transmission device according to a comparative example.

FIG. 6C is a diagram for describing a relationship between an IF signal and an optical carrier wave and a relationship between an optical transmitter and an optical receiver when using the optical transmission device according to the first embodiment of the present disclosure.

FIG. 7 is a diagram illustrating a hardware configuration of the optical transmission device according to the first embodiment of the present disclosure.

FIG. 8 is a block diagram illustrating a configuration of an optical transmission device according to a second embodiment of the present disclosure.

FIG. 9 is a diagram for describing a principal of optical modulation in an EA modulator according to the second embodiment of the present disclosure.

FIG. 10 is a diagram illustrating a hardware configuration of the optical transmission device according to the second embodiment of the present disclosure.

FIG. 11 is a flowchart illustrating a procedure of starting and operating the optical transmission device according to the second embodiment of the present disclosure.

FIG. 12 is a flowchart illustrating an operation of the optical transmitter according to the first and second embodiments of the present disclosure.

### DESCRIPTION OF EMBODIMENTS

Hereinafter, various embodiments of the present disclosure are described in detail with reference to the accompanying drawings. Note that, components denoted by the same or similar reference numerals in the drawings have the same or similar configurations or functions, and redundant description of such components is omitted.

### First Embodiment

### <Configuration>

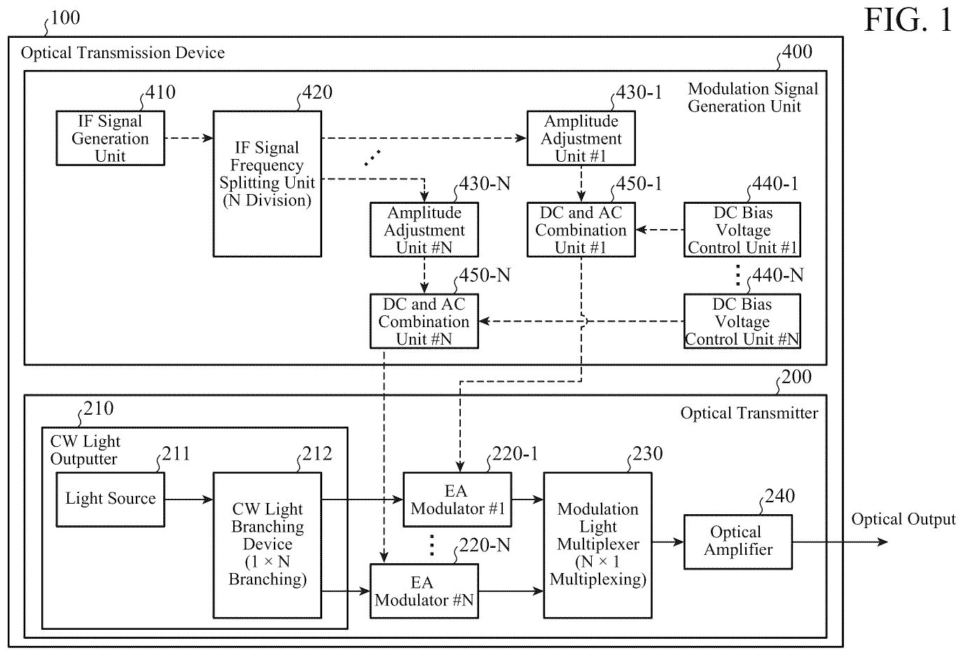

An optical transmission device 100 according to a first embodiment of the present disclosure is described with reference to FIGS. 1 to 7. Note that, in FIG. 1, a solid arrow indicates a flow of an optical signal, and a broken arrow indicates a flow of an electrical signal.

FIG. 1 is a block diagram illustrating a configuration of the optical transmission device 100 according to the first embodiment of the present disclosure.

The optical transmission device 100 is a device focusing on a transmission function of a communication device or an optical transceiver that performs transmission and reception of optical signals. The optical transmission device 100 can be used in an optical communication network including an optical fiber or a wireless space assuming optical spatial communication. In an actual system, an optical receiver and a control device that controls the optical receiver are included in the same housing together with the optical transmission device 100. In the first embodiment, a generally known device can be used for the optical receiver and the control device that controls the optical receiver, so that the detailed description thereof is omitted.

The optical transmission device 100 is a device that transmits signals of a plurality of channels such as an OFDM signal by an IFOF technology and the like, and can be used as, for example, a device for performing optical transmission in a mobile fronthaul of a wireless access network.

As illustrated in FIG. 1, the optical transmission device 100 includes an optical transmitter 200 and a modulation signal generation unit 400. The optical transmitter 200 converts an electrical modulation signal for transmission input as data information to be transmitted to one or a plurality of communication destinations into an optical signal, and outputs the converted optical signal. In many cases, the optical transmitter is formed as an optical device having at least one set of a light source function and a modulation function. The modulation signal for transmission is generally a high-speed electrical signal characterized by a DC bias voltage provided as an offset and a driving amplitude of an AC component.

### (Modulation Signal Generation Unit)

The modulation signal generation unit 400 generates the modulation signal for transmission and outputs the generated modulation signal for transmission to the optical transmitter 200. The modulation signal generation unit 400 may be implemented on a control board dedicated for the optical transmitter 200, or may be implemented on a control board for an entire optical transmission device 100. The modulation signal for transmission is a modulation signal accommodating signals of a plurality of channels (hereinafter, sometimes referred to as “channel signals”). That is, the modulation signal for transmission is the modulation signal including the plurality of channel signals. The plurality of channels is divided so as not to overlap each other in a frequency domain, and is independent of each other. Therefore, different channel signals are independent of each other.

### (Optical Transmitter)

As an example, the optical transmitter 200 includes a CW light outputter 210, electro-absorption modulators (hereinafter, referred to as EA modulators) 220 (220-1 to 220-N), a modulation light multiplexer 230, and an optical amplifier 240.

### (CW Light Output Unit)

The CW light outputter 210 generates continuous wave (CW) light to be a seed of the optical signal, and outputs the generated CW light to the EA modulators 220. As illustrated in FIG. 1, the CW light outputter 210 includes a light source 211 and a CW light branching device 212.

### (Light Source)

The light source 211 is, for example, a semiconductor laser (laser diode (LD)) that outputs the CW light. The light source 211 generates the CW light that is the seed light, and outputs the generated CW light to the CW light branching device 212.

### (CW Light Branching Device)

The CW light branching device 212 branches the CW light generated by the light source 211 into N pieces, and outputs the CW lights after branching to the N EA modulators 220-1 to 220-N as branched lights. Basic characteristics such as a carrier frequency of the CW light are the same before and after branching by the CW light branching device 212 except for an optical power. The CW light branching device 212 includes an optical coupler or a multimode interference waveguide.

### (EA Modulator)

The EA modulator 220 (220-1 to 220-N) is an example of an optical modulator in the present disclosure. In addition to the EA modulator 220, the technology of the present disclosure is applicable to an optical modulator having a non-linear modulation curve characteristic such as a ring resonator. The EA modulator 220 (220-1 to 220-N) is an external modulator provided outside the light source 211, and has a waveguide structure. EA modulators 220-1 to 220-N are connected in parallel to the modulation signal generation unit 400. Each EA modulator 220 (220-1 to 220-N) performs optical modulation on the CW light, which is the branched light input via the CW light branching device 212, with the modulation signal for transmission, which is the electrical signal applied via electrodes arranged along the waveguide, to generate the optical signal, and outputs the generated optical signal. When the electrical signal is applied to the EA modulator 220 (220-1 to 220-N), an electric field is generated in the waveguide to cause optical absorption of the CW light that passes therethrough, resulting in a reduction in optical power of the output light. The EA modulator 220 (220-1 to 220-N) utilizes such an optical absorption effect. The high-speed electrical signal is provided as the modulation signal for transmission, so that the EA modulator 220 (220-1 to 220-N) generates the optical signal in which optical intensity or optical power is modulated, and outputs the generated optical signal. In particular, a device in which the light source and the EA modulator are integrated is widely recognized as an electro-absorption modulator laser diode (EML-LD).

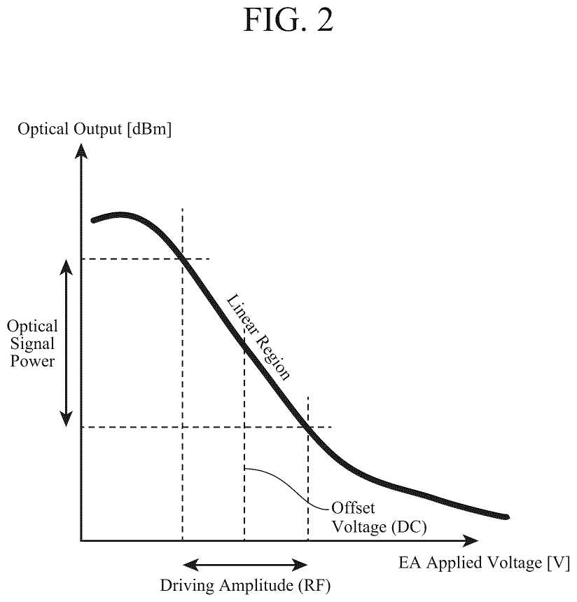

The modulation signal for transmission is a biased modulation signal for driving the EA modulator 220 (220-1 to 220-N), and is an electrical signal obtained by combining the DC bias voltage and the modulation signal of the driving amplitude. The EA modulator 220 has a relationship of power transmittance (optical output) with respect to a reversely applied voltage as illustrated in FIG. 2, that is, an extinction curve characteristic. In FIG. 2, the horizontal axis represents the reversely applied voltage, that is, a voltage value of the modulation signal for transmission, and the vertical axis represents the power transmittance, that is, the optical power, of the EA modulator 220. Note that, in the horizontal axis, the reversely applied voltage is a positive value.

In the extinction curve, the power transmittance changes with non-linearity with respect to the reversely applied voltage that is applied, so that the modulation signal for transmission to which an offset is appropriately provided is provided to the EA modulator 220 (220-1 to 220-N) so that the modulation is performed in a linear region in the extinction curve.

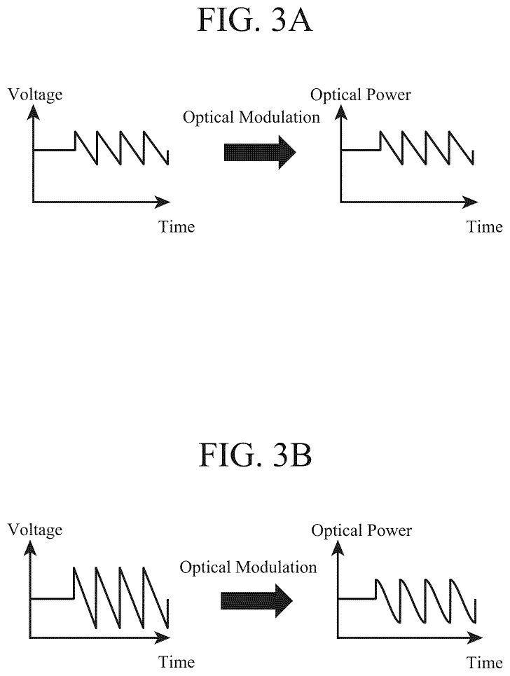

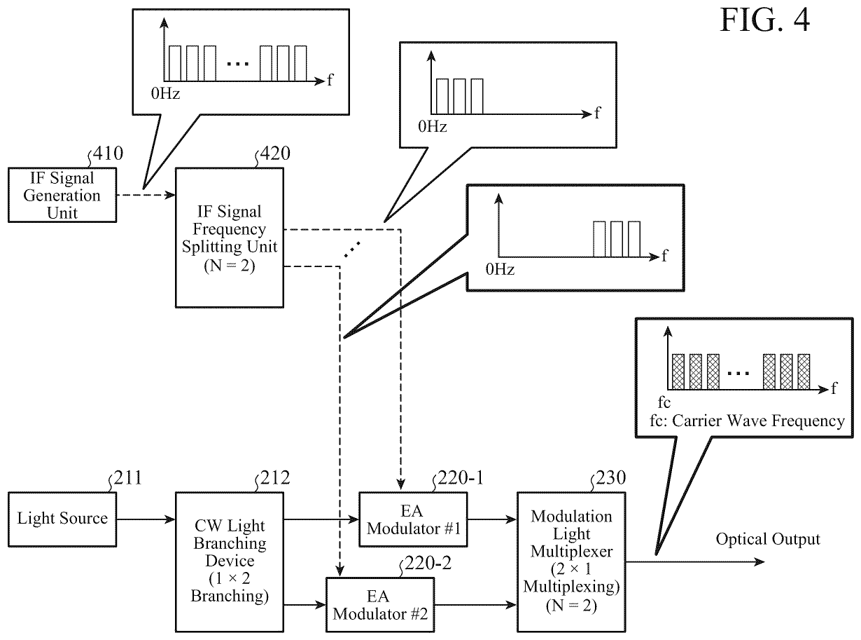

Here, as illustrated in FIG. 3A, a case where the optical modulation is performed in the linear region in the extinction curve is considered. FIG. 3A illustrates that linear optical modulation can be performed in a case where the driving amplitude is small. As the optical output power of the EA modulator, an optical output maintaining the same waveform shape as that of the input electrical signal is continuously obtained in time series.

In contrast, as illustrated in FIG. 3B, a case where the optical modulation is performed in a non-linear region in the extinction curve is considered. FIG. 3B illustrates that non-linear optical modulation is performed in a case where the driving amplitude is large. In this case, the optical output power of the EA modulator is the optical output having a waveform shape different from that of the electrical signal. Such characteristic leads to deterioration in signal quality in a case of multi-value modulation. In the OFDM modulation scheme also, a similar problem occurs because a multi-value QAM signal is used.

That is, in a case where the IFOF transmission scheme is assumed, when the number of signals of a plurality of channels to be frequency-multiplexed of the OFDM signal and the like increases and the driving amplitude increases depending on the increase in the number of signals, the optical modulation is performed in the non-linear region of the extinction curve, and the optical signal output from the EA modulator is distorted. That is, a constellation of a multi-value signal is uneven. Therefore, the distortion of the optical signal might increase an error rate of the optical signal.

Accordingly, in the first embodiment, in order to perform the optical modulation in the linear region while avoiding the optical modulation in the non-linear region of the extinction curve characteristic, the optical transmitter 200 includes a plurality of EA modulators 220 (220-1 to 220-N), and the channel is divided according to the number of the EA modulators 220. As a result, the driving amplitude per one EA modulator 220 can be reduced, so that the optical modulation can be performed in the linear region of the extinction curve characteristic.

This point is described with reference to FIGS. 1 and 4. FIG. 4 is a diagram illustrating a principle of the optical modulation in the linear region using the plurality of EA modulators 220. FIG. 4 illustrates a case where two EA modulators 220-1 and 220-2 are used as an example. For simplicity, complex conjugate components on the negative frequency side are not illustrated. In FIG. 4, an IF signal generation unit 410 of the modulation signal generation unit 400 generates, as the modulation signal, a broadband electrical signal accommodating radio signals of a plurality of channels to be transmitted by the optical transmission device 100. This modulation signal may be a signal transmitted as a downlink signal from a central unit (CU) or a distributed unit (DU), or a relay point close to these units, or may be a signal transmitted as an uplink signal from a relay point close to a radio unit (RU) to the CU or the DU, or the relay point close to these units. The IF signal generation unit 410 generates an IF signal assumed to be transmitted by one optical carrier wave.

Subsequently, a frequency splitting unit 420 divides the broadband IF signal into signals of the same number of bands as the number of EA modulators 220 in the frequency domain. In the example in FIG. 4, the number of EA modulators 220 is two, so that the frequency splitting unit 420 divides the IF signal into two. Note that, a value of the number of division N is any integer equal to or larger than 2 according to the number of EA modulators 220. A division may be implemented by a method, for example, of demultiplexing the IF signals in an analog domain using a splitter, and thereafter of removing frequency components other than the channel on the frequency domain selected in advance for each EA modulator 220 using a bandpass filter. In addition, the IF signal can be divided in the analog domain with various simple configurations. In a digital domain also, for example, a division can be performed by converting the broadband IF signal into the IF signals assumed to be transmitted to a plurality of optical carrier waves.

The IF signals divided into a plurality of pieces are each input to amplitude adjustment units 430 (430-1 to 430-N) illustrated in FIG. 1. The amplitude adjustment unit 430 (430-1 to 430-N) includes a driver, and adjusts the driving amplitude of the input IF signal. For example, the amplitude adjustment unit 430 (430-1 to 430-N) amplifies the driving amplitude of the input IF signal. The amplitude adjustment unit 430 (430-1 to 430-N) outputs the IF signal after the amplitude adjustment to a corresponding DC and AC combination unit 450 (450-1 to 450-N). Note that, it is sufficient that the amplitude necessary for performing the optical modulation by the EA modulator 220 is ensured, so that it is possible that the amplitude adjustment unit 430 (430-1 to 430-N) is arranged only in a preceding stage of the frequency splitting unit 420 or arranged in multiple stages in both the preceding stage and a subsequent stage of the frequency splitting unit 420.

The DC and AC combination unit 450 (450-1 to 450-N) illustrated in FIG. 1 applies the DC bias voltage obtained from a DC bias voltage control unit 440 (440-1 to 440-N) to the IF signal output from the amplitude adjustment unit 430 (430-1 to 430-N), generates the modulation signal for transmission to which an offset is provided, and applies the generated modulation signal for transmission to the EA modulator 220 (220-1 to 220-N). The DC and AC combination unit 450 (450-1 to 450-N) can be implemented by a bias tee.

From the CW light outputter 210 to each EA modulator 220 (220-1 to 220-N), the CW light output from one light source 211 and branched is input as the branched light. The branched lights after being branched have substantially the same frequency and wavelength in a free space. Each EA modulator 220 (220-1 to 220-N) converts the input modulation signal for transmission into the optical signal. That is, each EA modulator 220 (220-1 to 220-N) optically modulates the intensity of the branched CW light according to the input modulation signal for transmission, and outputs the optically modulated CW light to the modulation light multiplexer 230 as the optical signal.

### (Modulation Light Multiplexer)

The modulation light multiplexer 230 multiplexes the optical signals output from the EA modulators 220 (220-1 to 220-N). The modulation light multiplexer 230 includes, for example, an optical coupler or a multimode interference waveguide.

### (Optical Amplifier)

The optical amplifier 240 amplifies the multiplexed optical signal in consideration of optical attenuation during fiber transmission. Here, the optical amplifier 240 includes, for example, a semiconductor optical amplifier (SOA) or an erbium-doped optical fiber amplifier (EDFA). In a case where the optical amplifier 240 is implemented by the SOA, the optical amplifier 240 may be formed of the same optical semiconductor element as that of the EA modulator 220 and may be optically connected by a waveguide. Note that, in a case where it is not necessary to perform optical amplification, the optical amplifier 240 may be omitted.

The optically multiplexed optical signal is output from the optical transmitter 200 via, for example, an optical fiber. When the optical signal is observed, this can be treated as being apparently generated by a pair of one light source and one optical modulator (EA modulator 220). Actually, the optical transmitter 200 has the configuration as described above, so that the optical signal is generated by one light source 211 and a plurality of optical modulators (EA modulators 220-1 to 220-N).

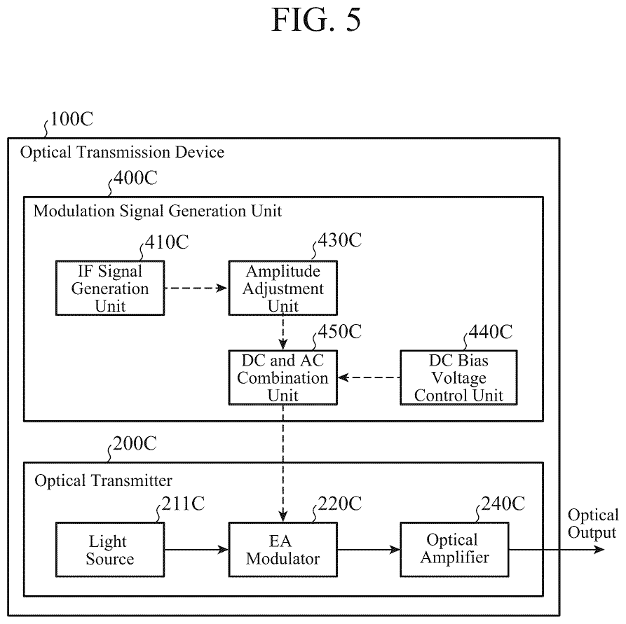

FIG. 5 illustrates a configuration of a normal optical transmitter 200C using one EA modulator 220C for comparison. One light source 211C and one EA modulator 220C are formed as a pair, and one electrical modulation signal for transmission is input to one EA modulator 220C.

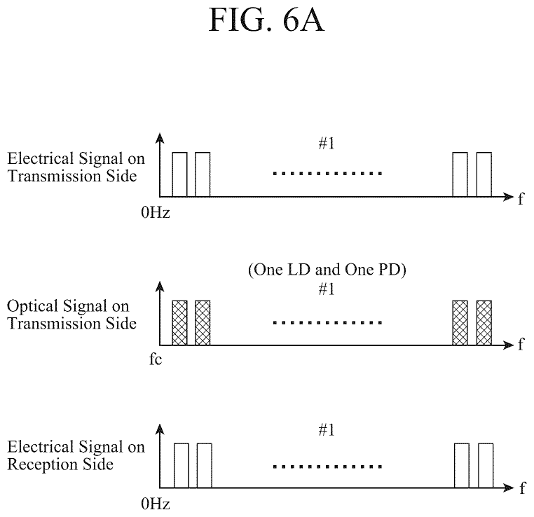

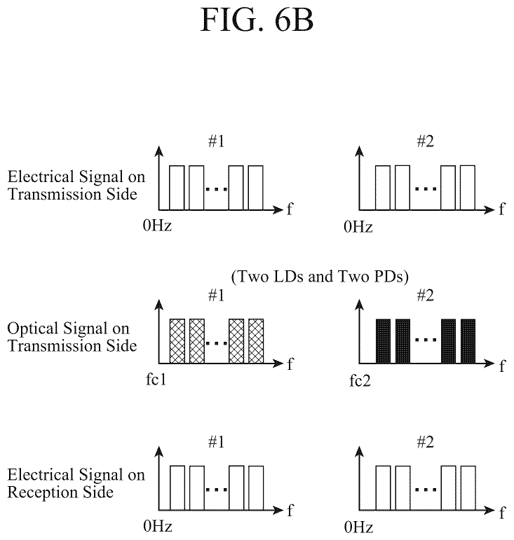

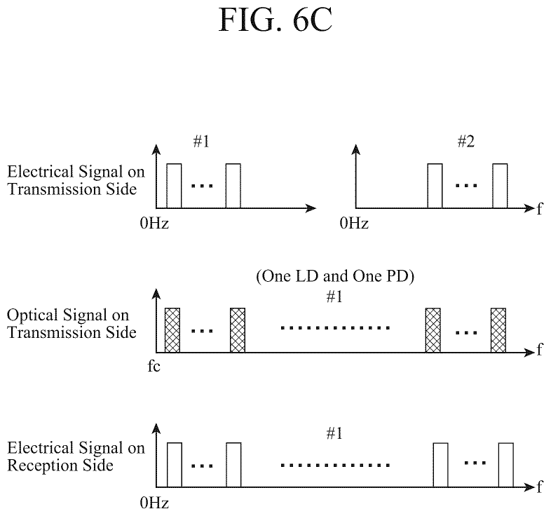

Each of FIGS. 6A to 6C is a diagram for describing a relationship between an IF signal and an optical carrier wave and a relationship between an optical transmitter and an optical receiver in short. More specifically, FIG. 6A is a diagram for describing the relationship between the IF signal and the optical carrier wave and the relationship between the optical transmitter and the optical receiver in a case where one carrier wave (wavelength) and one EA modulator are used. FIG. 6B is a diagram for describing the relationship between the IF signal and the optical carrier wave and the relationship between the optical transmitter and the optical receiver in a case where a plurality of carrier waves (wavelengths) and the plurality of EA modulators are used. FIG. 6C is a diagram for describing the relationship between the IF signal and the optical carrier wave and the relationship between the optical transmitter and the optical receiver in a case where one carrier waves (wavelengths) and a plurality of EA modulators are used. FIGS. 6A and 6B relate to a comparative example, and FIG. 6C relates to the first embodiment of the present disclosure.

According to the configuration of the optical transmitter including one EA modulator illustrated in FIG. 6A, one broadband IF signal is input to one EA modulator, and the optical signal is transmitted by one optical carrier wave. This configuration is a simple configuration, but as described above, the number of bands or channels accommodated as the IF signal is limited by a non-linear modulation curve of the EA modulator.

In a case where a plurality of optical carrier waves having different frequencies and wavelengths is used as illustrated in FIG. 6B, the number of bands or channels to be accommodated in the IF signal can be increased depending on the number of EA modulators, but it is necessary to prepare a plurality of optical transmitters, which leads to an increase in size and power consumption of an entire optical transmission device. Although a plurality of pairs of the light source and the EA modulator can be formed in one optical transmitter, due to transmission by a plurality of optical carrier waves, it is necessary to receive the plurality of optical carrier waves separately in the optical receiver at a communication destination.

In the case of the first embodiment illustrated in FIG. 6C, the IF signals divided into the plurality of pieces are input to the plurality of EA modulators 220 (220-1 to 220-N), and the optical signal is transmitted by one optical carrier wave. In this case, it is possible to increase the number of bands or channels accommodated as the IF signals while performing the optical modulation in the linear region of each EA modulator 220. In many cases, the plurality of EA modulators 220 (220-1 to 220-N) can be formed of one optical semiconductor element (chip), so that an increase in size and power consumption can be suppressed as compared with a case in FIG. 6B. The optical signal is transmitted by one optical carrier wave, so that it is not necessary to separate the optical carrier waves in the optical receiver at the communication destination.

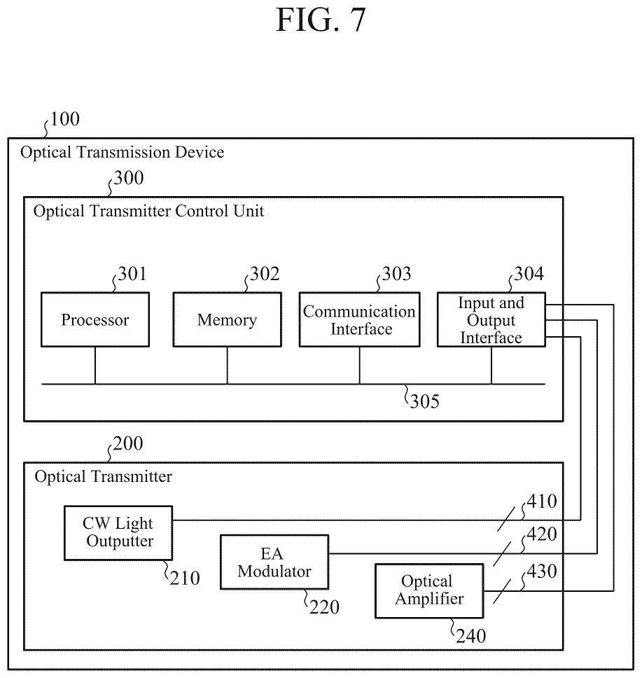

Next, with reference to FIG. 7, a hardware configuration of the optical transmission device 100 illustrated in FIG. 1 is described. Note that, the hardware configuration of the optical transmitter 200 is as described with reference to FIG. 1, so that the redundant description is omitted.

An optical transmitter control unit 300 includes a processor 301 such as a central processing unit (CPU) or a system large scale integration (LSI), a memory 302 including a random access memory (RAM), a read only memory (ROM) and the like, a communication interface 303, and an input and output interface 304.

The processor 301, the memory 302, the communication interface 303, and the input and output interface 304 are connected to a bus 305, and exchange data, a control signal and the like with one another via the bus 305.

The processor 301 reads a program recorded in the memory 302 and executes processing. The memory 302 stores various data, a program for implementing an operation of the optical transmission device 100 according to the first embodiment, a processing program necessary for starting the optical transmission device 100 and the like.

The communication interface 303 is used for transmission and reception of the data and control signal between various components inside the optical transmission device 100 and various components outside the optical transmission device 100.

The input and output interface 304 transmits and receives the control signal and the modulation signal between the optical transmitter 200 and the optical transmitter control unit 300 via electrical wiring. For example, a current for generating light is injected into the light source 211 to the CW light outputter 210, and the modulation signal for transmission is supplied to the EA modulator 220.

The functions performed by the components of the modulation signal generation unit 400 are implemented by the processor 301 executing a program stored in the memory 302 for operating as a device that performs the optical transmission.

Although the optical transmitter control unit 300 includes an electric circuit not including an optical device, the optical transmitter control unit 300 is not necessarily required to be outside the optical transmitter 200. For example, a part of the electric circuit forming the optical transmitter control unit 300 may be forming in the optical transmitter 200.

### Second Embodiment

### <Configuration>

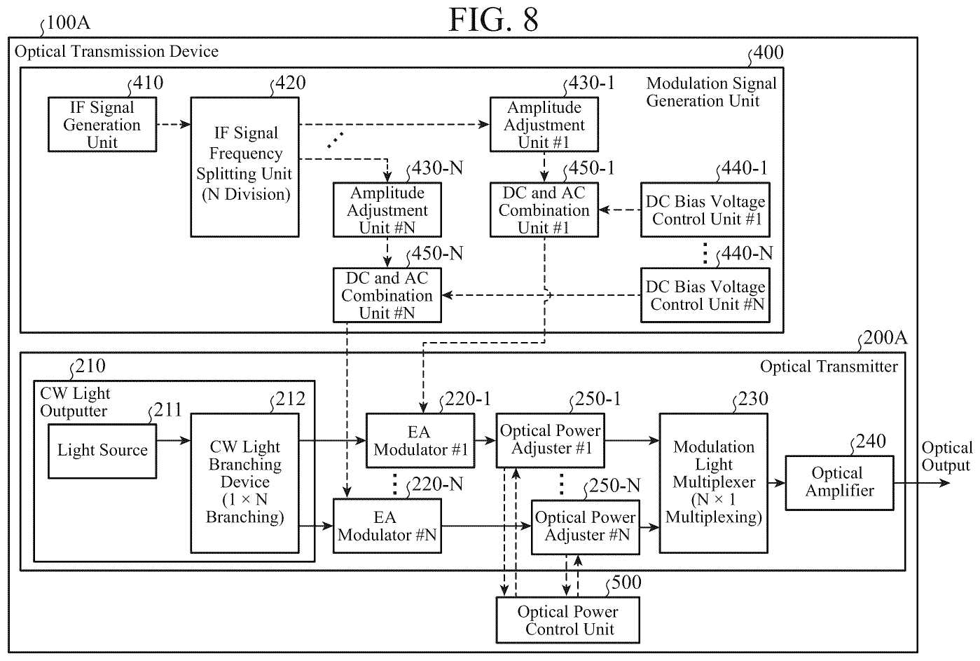

Next, an optical transmission device 100A according to a second embodiment of the present disclosure is described with reference to FIGS. 8 to 11. The optical transmission device 100A includes an optical transmitter 200A obtained by adding optical power adjusters 250 (250-1 to 250-N) to the optical transmitter 200 according to the first embodiment, and further includes an optical power control unit 500 that controls each optical power adjuster 250. In the second embodiment, an optical power output from each EA modulator 220 can be adjusted.

Each optical power adjuster 250 (250-1 to 250-N) is implemented by electrodes arranged along a waveguide, and a plurality of optical power adjusters 250-1 to 250-N is connected in parallel to the optical power control unit 500. When optical absorption occurs in the waveguide due to a DC bias voltage applied via the electrodes arranged along the waveguide, a photocurrent occurs between the electrodes for application. An optical absorption amount and eventually power transmittance in the optical power adjuster 250 can be estimated by a magnitude of the photocurrent. By using this property, by setting the DC bias voltages to be applied to the respective optical power adjusters 250 (250-1 to 250-N) to the same value, it is possible to estimate a relative variation of the optical outputs among the plurality of EA modulators 220-1 to 220-N.

For example, for the estimated relative variation of the optical outputs among the plurality of EA modulators 220-1 to 220-N, when it is desired to adjust from the state in which the relative variation exists to the state in which the same optical power is output, a degree of optical absorption can be adjusted by adjusting the respective DC bias voltages, and the optical powers can be made even. Note that, at that time, different values are used as the DC bias voltage in each EA modulator 220, so that the optical power is not observed. The optical power is observed when the device is started.

Because an optical amplification effect (SOA function) acts on the optical power adjuster 250 by applying a forward DC bias voltage or flowing a DC bias current to a PN junction of a semiconductor, as a method of adjusting the optical power, a method of uniformizing the optical power by adjusting the degree of optical amplification may be used.

At the time of optical power observation, the optical power control unit 500 applies a DC bias in a reverse direction in a PN junction of the semiconductor to the optical power adjuster 250 (250-1 to 250-N), causes optical absorption of a part of the input optical signal, and estimates the power of the input light from a generated amount of optical absorption current. Next, the optical power control unit 500 outputs a DC bias voltage or a DC bias current set in advance so as to obtain a desired power ratio at the time of optical power adjustment.

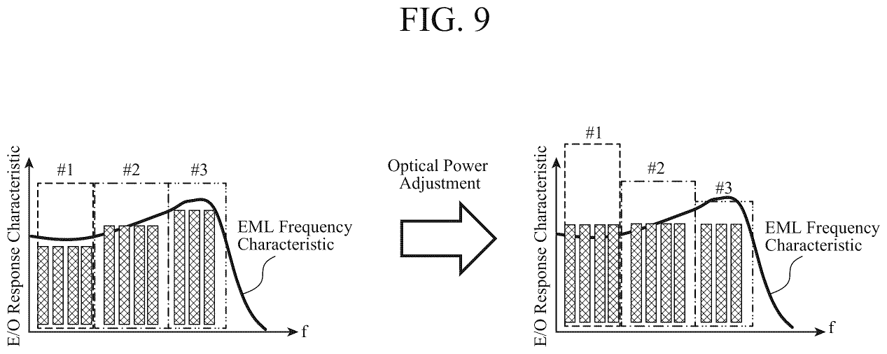

As illustrated in FIG. 9, by using the configuration of the second embodiment, the original IF signal is divided in the frequency domain, and the optical modulation is performed by the EA modulator 220 (220-1 to 220-3), so that the power ratio of the optical signal from each EA modulator 220 (220-1 to 220-3) can be changed freely.

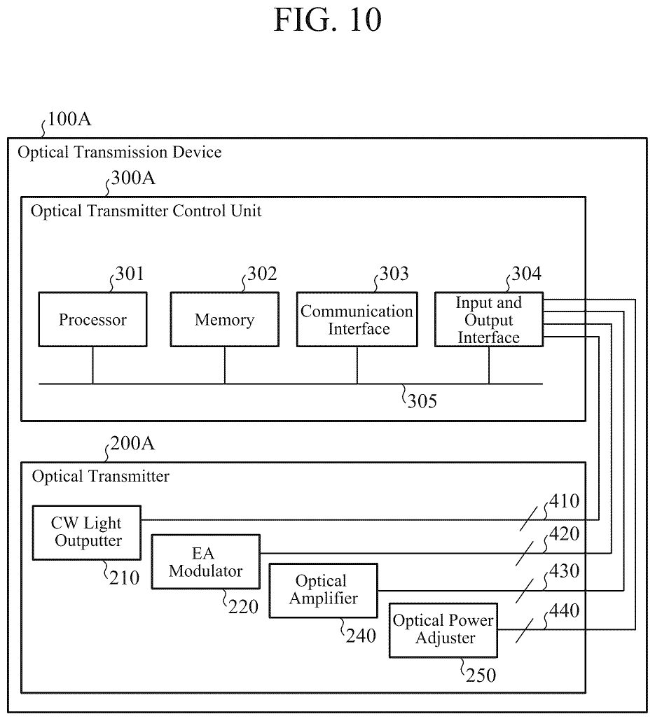

Next, with reference to FIG. 10, a hardware configuration of the optical transmission device 100A illustrated in FIG. 8 is described.

As a change from the configuration of the first embodiment, the optical transmitter 200A according to the second embodiment includes the optical power adjuster 250 in the optical transmitter 200. The optical power adjuster 250 is implemented by electrodes arranged along the waveguide.

The optical power control unit 500 is a functional unit that performs operations such as current reading, application of the DC bias voltage or injection of the DC bias current, reference to a lookup table, simple arithmetic processing and the like, and is implemented by the optical transmitter control unit 300A similarly to the modulation signal generation unit 400. That is, when the processor 301 executes the program stored in the memory 302, the function of the optical power control unit 500 is implemented. The optical transmitter control unit 300A has the configuration similar to that of the optical transmitter control unit 300.

### <Operation: Optical Transmission Device>

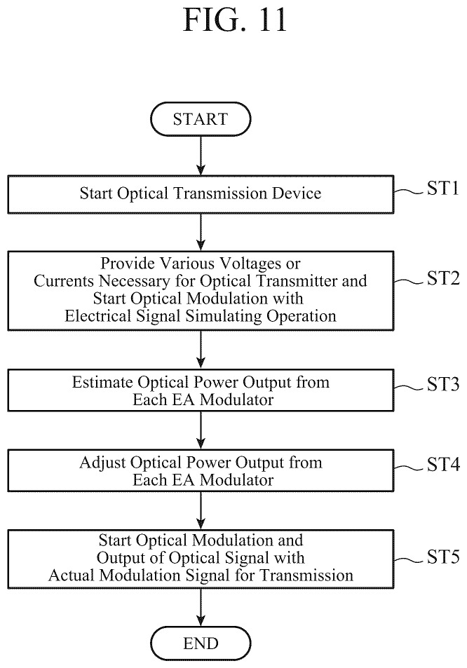

Next, an operation of the optical transmission device 100A according to the second embodiment is described with reference to FIG. 11.

At step ST1, the optical transmission device 100A is started.

At step ST2, the optical transmitter control unit 300A applies various necessary voltages or currents to the optical transmitter 200A, and starts the optical modulation with an electrical signal simulating an operation.

At step ST3, the optical transmitter control unit 300A estimates optical power output from each EA modulator 220 (220-1 to 220-N).

At step ST4, the optical transmitter control unit 300A adjusts the optical power output from each EA modulator 220 (220-1 to 220-N).

At step ST5, the optical transmitter control unit 300A starts the optical modulation and an output of an optical signal with an actual modulation signal for transmission.

In this manner, the optical power is adjusted before the optical transmission device 100A is started. That is, the operation at step ST4 is performed before the operation at step ST5. Note that, step ST3 of the optical power observation may be skipped before the adjustment or when the relative variation between the EA modulators 220 or a desired optical power ratio can be predicted.

### <Operation: Optical Transmitter>

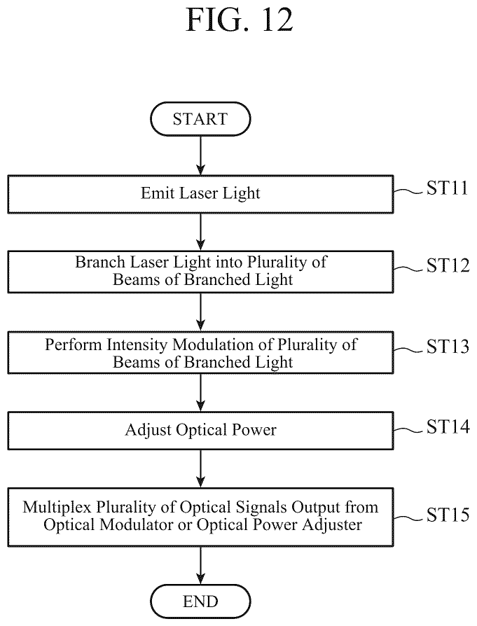

The optical transmitter 200 according to the first embodiment and the optical transmitter 200A according to the second embodiment are described with reference to FIG. 12. Steps ST11 to ST13 and ST15 are steps common to the first embodiment and the second embodiment. Step ST14 is a step performed in a case of the second embodiment, and is not performed in a case of the first embodiment.

At step ST11, the light source 211 emits laser light having a single wavelength.

At step ST12, the CW light branching device 212 branches the laser light emitted from the light source 211 into branched lights.

At step ST13, the EA modulators 220-1 to 220-N optically modulate intensities of the branched lights by respective channel signals independent of each other, and output the optically modulated branched lights as the optical signals.

At step ST14, the optical power adjusters 250-1 to 250-N adjust the optical powers of the optical signals output from the EA modulators 220-1 to 220-N, respectively, and output the adjusted optical signals.

At step ST15, the modulation light multiplexer 230 multiplexes the plurality of optical signals output from the EA modulators 220-1 to 220-N or the plurality of optical signals output from the optical power adjusters 250-1 to 250-N, and outputs the multiplexed optical signal.

### <Supplement>

Some aspects of the various embodiments described above are summarized as follows.

### (Supplement 1)

An optical transmitter (200; 200A) of Supplement 1 includes optical modulators (220-1 to 220-N) to optically modulate intensities of branched lights obtained by branching a laser light having a single wavelength emitted from a single light source by respective channel signals independent of each other, and output the optically modulated branched lights as optical signals; and a modulation light multiplexer (230) to multiplex the optical signals output from the optical modulators and output the multiplexed optical signal.

### (Supplement 2)

The optical transmitter (200; 200A) of Supplement 2 is the optical transmitter according to Supplement 1, and further includes a light source (211) to emit the laser light having the single wavelength; and an optical branching device (212) to branch the emitted laser light into the branched lights.

### (Supplement 3)

The optical transmitter (200A) of Supplement 3 is the optical transmitter according to Supplement 1 or 2, and further includes optical power adjusters (250) to adjust respective optical powers of the optical signals output from the optical modulators, and output the adjusted optical signals, in which the modulation light multiplexer multiplexes the optical signals output from the optical power adjusters in place of the optical signals output from the optical modulators.

### (Supplement 4)

An optical transmission device (100; 100A) of Supplement 4 includes the optical transmitter (200; 200A) according to any one of Supplement 1 to 3; and a modulation signal generation unit (400) to generate channel signals independent of each other and output the generated channel signals, in which the optical modulators are connected in parallel to the modulation signal generation unit.

### (Supplement 5)

An optical transmission device (100A) of Supplement 5 includes the optical transmitter (200A) according to Supplement 3; and an optical power control unit (500) to adjust optical powers output from the optical power adjusters, in which the power adjusters are connected in parallel to the optical power control unit.

### (Supplement 6)

An optical transmission device (100A) of Supplement 6 is the optical transmission device according to Supplement 5, and further includes a modulation signal generation unit (400) to generate channel signals independent of each other and output the generated channel signals, in which the optical modulators are connected in parallel to the modulation signal generation unit.

### (Supplement 7)

An optical transmission method of Supplement 7 is an optical transmission method performed by an optical transmitter (200; 200A) including optical modulators (220-1 to 220-N) and a modulation light multiplexer (230), and includes steps of optically modulating intensities of branched lights obtained by branching a laser light having a single wavelength emitted from a single light source by respective channel signals independent of each other, and outputting the optically modulated branched lights as optical signals performed by the optical modulators (220-1 to 220-N); and multiplexing the optical signals output from the optical modulators and outputting the multiplexed optical signal performed by the modulation light multiplexer (230).

Note that, the embodiments can be combined, and the embodiments can be appropriately modified or omitted.

### INDUSTRIAL APPLICABILITY

The optical transmitter of the present disclosure can be used as an optical transmitter that optically modulates an optical carrier wave of a single wavelength with a plurality of channel signals.

### REFERENCE SIGNS LIST

100: optical transmission device, 100A: optical transmission device, 100C: optical transmission device, 200: optical transmitter, 200A: optical transmitter, 200C: optical transmitter, 210: CW light outputter, 211: light source, 211C: light source, 212: CW light branching device, 220 (220-1 to 220-N): electro-absorption modulator (EA modulator; optical modulator), 220C: EA modulator, 230: modulation light multiplexer, 240: optical amplifier, 240C: optical amplifier, 250 (250-1 to 250-N): optical power adjuster, 300: optical transmitter control unit, 300A: optical transmitter control unit, 301: processor, 302: memory, 303: communication interface, 304: input and output interface, 305: bus, 400: modulation signal generation unit, 410: IF signal generation unit, 410C: IF signal generation unit, 420: frequency splitting unit, 430 (430-1 to 430-N): amplitude adjustment unit, 430C: amplitude adjustment unit, 440 (440-1 to 440-N): DC bias voltage control unit, 440C: DC bias voltage control unit, 450 (450-1 to 450-N): DC and AC combination unit, 450C: DC and AC combination unit, 500: optical power control unit

1. An optical transmission device comprising:
an optical transmitter comprising:
optical modulators to optically modulate intensities of branched lights obtained by branching a laser light having a single wavelength emitted from a single light source by respective channel signals independent of each other, and output the optically modulated branched lights as optical signals;
optical power adjusters to adjust respective optical powers of the optical signals output from the optical modulators, and output the adjusted optical signals; and
a modulation light multiplexer to multiplex the optical signals output from the optical power adjusters and output a multiplexed optical signal;
a modulation signal generator, connected in parallel to the optical modulators, to generate a same number of channel signals each including signals independent of each other as a number of the optical modulators, and output the generated channel signals as the channel signals independent of each other to the optical modulators; and
an optical power controller, connected in parallel to the optical power adjusters, to adjust optical powers output from the optical power adjusters freely.

2. The optical transmission device according to claim 1, the optical transmitter further comprising:
a light source to emit the laser light having the single wavelength; and
a multimode interference waveguide to branch the emitted laser light into three or more branched lights,
wherein the optical modulators optically modulate the branched lights branched by multimode interference waveguide.

3. An optical transmission method comprising:
generating a same number of channel signals each including signals independent of each other as a number of optical modulators, to output the generated channel signals as channel signals independent of each other to the optical modulators;
optically modulating intensities of branched lights obtained by branching a laser light having a single wavelength emitted from a single light source by the channel signals independent of each other respectively, to output the optically modulated branched lights as optical signals;
adjusting respective optical powers of the output optical signals to output the adjusted optical signals;
adjusting the output optical powers freely;
multiplexing the optical signals whose optical power is adjusted to output a multiplexed optical signal.
